(19) United States
(12) Patent Application Publication
(10) Pub. No.: US 2026/0058918 A1
(43) Pub. Date: Feb. 26, 2026

(54) MANAGING PRIORITY TRAFFIC IN A WIRELESS NETWORK USING A DEDICATED QUALITY OF SERVICE (QOS) FLOW

(71) Applicant: DISH Wireless L.L.C., Englewood, CO (US)

(72) Inventor: Xiaowen S. Robinson, Great Falls, VA (US)

(21) Appl. No.: 18/812,608

(22) Filed: Aug. 22, 2024

(51) Int. Cl. H04L 47/80; H04W 28/02

(52) U.S. Cl. CPC H04L 47/805; H04W 28/0268

(57) ABSTRACT

Technology that includes receiving a first data packet associated with a data communication session established between a user equipment (UE) and a wireless network, and determining that the first data packet is associated with a first level of priority different from a second level of priority. In response, a first quality-of service (QoS) flow is selected, the first QoS flow defined by a first set of QoS parameters associated with a first set of network resources. The first QoS flow is different from a second QoS flow defined by a second set of QoS parameters associated with a second set of network resources. Each of the first QoS flow and the second QoS flow pertain to the same data communication session. The first data packet can be routed over the first QoS flow supported by the first set of network resources within the data communication session.

### TECHNICAL FIELD

This specification relates to routing of priority data traffic in wireless networks such as a 5G Open Radio Access Network (O-RAN).

### BACKGROUND

In advanced wireless networks such as a 5G O-RAN, certain users may be designated as priority users such that data traffic to and from corresponding user-equipment (UEs) is prioritized over other data traffic to and from UEs corresponding to other users.

### SUMMARY

In one aspect, this document features a method that includes receiving, at one or more computing devices, a first data packet associated with a data communication session established between a user equipment (UE) and a wireless network, and determining, based on one or more parameters associated with the first data packet and one or more configured rules, that the first data packet is associated with a first level of priority different from a second level of priority. The first and second levels of priority define a relative prioritization of data packets within the wireless network. The method also includes selecting, in response—from (i) a first quality-of service (QoS) flow associated with a set of filter criteria and (ii) a second QoS flow associated with different set of filter criteria—the first QoS flow, wherein the first QoS flow is defined by a first set of QoS parameters associated with a first set of network resources. The first QoS flow is different from a second QoS flow defined by a second set of QoS parameters associated with a second set of network resources. Each of the first QoS flow and the second QoS flow pertain to the same data communication session. The method further includes routing the first data packet over the first QoS flow supported by the first set of network resources within the data communication session.

In another aspect, this document features a system that includes memory configured to store computer-readable instructions, and one or more computing devices operatively coupled to the memory, configured to execute the computer-readable instructions to perform various operations. The operations include receiving a first data packet associated with a data communication session established between a user equipment (UE) and a wireless network, and determining, based on one or more parameters associated with the first data packet and one or more configured rules, that the first data packet is associated with a first level of priority different from a second level of priority. The first and second levels of priority define a relative prioritization of data packets within the wireless network. The operations also include selecting, in response—from (i) a first quality-of service (QoS) flow associated with a set of filter criteria and (ii) a second QoS flow associated with different set of filter criteria—the first QoS flow, wherein the first QoS flow is defined by a first set of QoS parameters associated with a first set of network resources. The first QoS flow is different from a second QoS flow defined by a second set of QoS parameters associated with a second set of network resources. Each of the first QoS flow and the second QoS flow pertain to the same data communication session. The operations further include routing the first data packet over the first QoS flow supported by the first set of network resources within the data communication session.

In another aspect, this document features one or more non-transitory computer-readable storage devices configured to store computer-readable instructions, which, upon execution by one or more computing devices cause the one or more computing devices to perform various operations. The operations include receiving a first data packet associated with a data communication session established between a user equipment (UE) and a wireless network, and determining, based on one or more parameters associated with the first data packet and one or more configured rules, that the first data packet is associated with a first level of priority different from a second level of priority. The first and second levels of priority define a relative prioritization of data packets within the wireless network. The operations also include selecting, in response—from (i) a first quality-of service (QoS) flow associated with a set of filter criteria and (ii) a second QoS flow associated with different set of filter criteria—the first QoS flow, wherein the first QoS flow is defined by a first set of QoS parameters associated with a first set of network resources. The first QoS flow is different from a second QoS flow defined by a second set of QoS parameters associated with a second set of network resources. Each of the first QoS flow and the second QoS flow pertain to the same data communication session. The operations further include routing the first data packet over the first QoS flow supported by the first set of network resources within the data communication session.

Each of the above aspects can include one or more of the following features.

The method or the operations can include receiving, at the one or more computing devices, a second data packet associated with the data communication session, and determining, based on one or more parameters associated with the second data packet and the one or more configured rules, that the second data packet is associated with the second level of priority. The method or the operations can also include, selecting, in response, the second QoS flow defined by the second set of QoS parameters associated with the second set of network resources, and routing the second data packet over the second QoS flow provided by the second set of network resources within the data communication session.

Both the first QoS flow and the second QoS flow can be set up during establishment of the PDU session. The one or more parameters associated with the first data packet can include at least one of: (i) an IP address associated with the source and/or destination of the first data packet, (ii) a port number associated with an origin or destination of the first data packet, (iii) an application associated with the first data packet, or (iv) a communication protocol associated with the first data packet. The wireless network can include a radio access network (RAN) and a core network associated with a 5G standalone (SA) network, and determining that the first data packet is associated with the first level of priority can include accessing one or more filtering criteria configured by a policy control function (PCF) module of the core network of the 5G SA network. The one or more computing devices can be associated with the user equipment (UE), and the first data packet is a portion of uplink data traffic originating at the UE. The wireless network can include a radio access network (RAN) and a core network associated with a 5G standalone (SA) network, the one or more computing devices can be associated with a network module of the core network of the 5G SA network, and the first data packet can be a portion of downlink data traffic being transmitted to the UE. The wireless network can include a radio access network (RAN) and a core network associated with a 5G standalone (SA) network, and the data communication session can be a protocol data unit (PDU) session established between the UE and the 5G SA network.

Various implementations of the technology described herein may provide one or more of the following advantages.

By distinguishing high-priority data traffic from non-high-priority data traffic and managing them accordingly, unnecessary overuse of valuable network resources can be reduced as compared to systems that blindly route data traffic from priority users through a dedicated resource-intensive DNN and/or a high-QoS flow within a DNN. This in turn can improve efficiency of hardware use, and reduce power consumption without any perceptible degradation of service in advanced wireless networks such as a 5G-standalone (SA) network.

Other features and advantages of the description will become apparent from the following description, and from the claims. Unless otherwise defined, the technical and scientific terms used herein have the same meaning as commonly understood by one of ordinary skill in the art to which this invention belongs.

### BRIEF DESCRIPTION OF THE DRAWINGS

FIG. 1 is a diagram of an example of a network environment and a user equipment (UE) device connected to the network environment.

FIG. 2 is a schematic diagram illustrating routing of data packets over multiple Quality of Service (QoS) flows within a same data communication session.

FIG. 3 is a flowchart of an example process for routing of data packets over multiple QoS flows within a same data communication session.

FIG. 4 is a schematic diagram illustrating routing of data packets over multiple data communication sessions with respective QoS parameters.

FIG. 5 is a flowchart of a process for routing of data packets over multiple data communication sessions with respective QoS parameters.

FIG. 6 is a diagram illustrating an example of a computing environment usable to implement technology described herein.

### DETAILED DESCRIPTION

The technology described herein relates to differential-treatment/management of data traffic in advanced wireless networks such as 5G-SA based on determining whether or not the data traffic is deemed to be high-priority. Data service to a UE in advanced wireless networks such as a 5G SA can be facilitated via a protocol data unit (PDU) session set up between the UE, 5G RAN and the 5G-core over a particular network slice. Network slicing, for example as utilized in a 5G SA, involves partitioning a physical network infrastructure into several virtual networks, each being associated with corresponding allocated resources and quality of service (QoS) criteria. These virtual networks can be distinguished from one another by unique slice identifier and Data Network Names (DNNs), which the 5G SA network can use to direct traffic differentially to particular network slices.

A PDU session through a DNN is set up automatically with a default QoS flow. To support data traffic for priority users (e.g., via priority traffic identification and priority treatment to data traffic to and from UEs associated with priority users), a particular DNN with corresponding QoS criteria associated with the default QoS flow can be set up. For example, to support high-importance data service to and from UEs associated with government-authorized personnel, emergency responders etc., the particular DNN can be provisioned with a high priority QoS associated with the default QoS flow to support a high priority treatment. However, a priority user may use the same PDU session and the high priority default QoS flow for both high-priority applications (e.g. video conference with a government agency) as well as non-high-priority applications (e.g. ordering pizza). Routing the non-high-priority applications through a high-QoS PDU session and QoS flow can lead to potential unnecessary overuse of valuable network resources.

In one aspect, to separate high-priority and non-high-priority traffic, the technology described herein espouses the use of multiple QoS flows within a same PDU session established through a DNN. For priority users, traffic associated with particular applications or URLs (e.g., secure video calling applications, high priority webpages etc.) are switched to a dedicated high-QoS flow, while non-high-priority traffic are routed through a default, relatively low QoS flow. The dedicated, high QoS flow and the default relatively low-QoS flow are both established on the same DNN PDU session but with different QoS profiles. By providing for separate QoS flows—with different resource allocations—the use of the dedicated high-QoS flow can be limited to high priority traffic only, while routing regular data traffic through a default QoS flow that utilizes relatively lower amount of resources.

In another aspect, to separate high-priority and non-high-priority traffic, the technology described herein espouses routing the two types of traffic through separate DNNs altogether. A high-priority DNN associated with specified applications and/or access to certain networks (e.g., high security government networks) can be configured and stored in the UE or a subscriber identification module (SIM) associated with the UE. If a URL requested from the UE, or an application used on the UE, is determined as high-priority, the corresponding data traffic is routed through a PDU established through the high-priority DNN. On the other hand, if the URL or application is not determined to be high-priority, the corresponding data traffic is routed through a default DNN that can be less resource-intensive as compared to the high-priority DNN.

As such, unnecessary overuse of valuable network resources can be reduced as compared to systems that blindly route data traffic from priority users through a high-priority PDU session and/or a high priority QoS flow—which in turn can improve efficiency of hardware use, and reduce power consumption without any perceptible degradation of service.

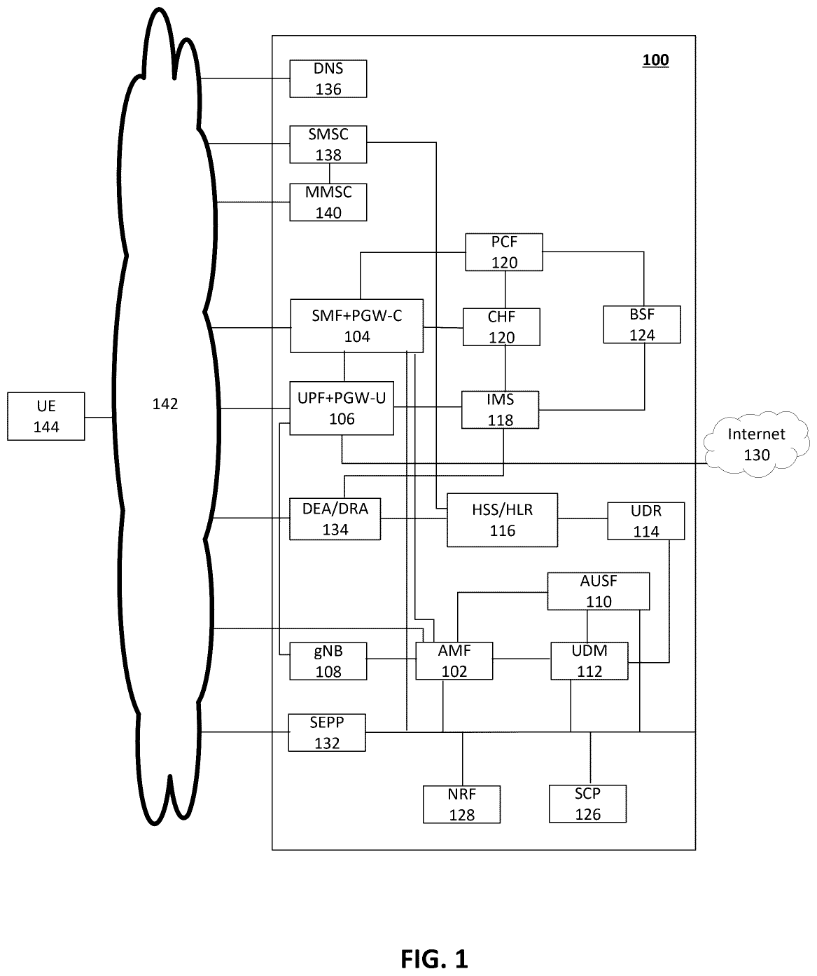

FIG. 1 depicts a diagram of an exemplary network environment 100 and a user equipment (UE) device 144 connected to the exemplary network environment. As used herein, a network environment (sometimes referred to herein simply as an environment) refers to a set of multiple devices, modules, and functions that are configured to jointly enable wireless communication. For example, a network environment can include a 5G network that includes a set of multiple devices, radio access network (RAN)/core network functions, and application functions that are configured and integrated to jointly enable wireless communication. An environment, such as the environment 100, can be a portion of a 5G New Radio (“5G-NR” or simply “5G”) cellular network environment. Standards for cellular network architectures have previously been described, for example, in 3GPP TS 23.501 (for 5G networks) and 3GPP TS 23.401 (for 4G long-term evolution “LTE” networks) (the entireties of which are hereby incorporated by reference). While FIG. 1 shows an exemplary architecture for a network environment (i.e., environment 100), it is not intended to be limiting. The lines depicted in FIG. 1 that connect network elements are indicative of the possibility of direct communication between those network elements.

Network environment 100 includes a packet core network, which includes an access management function (AMF) 102, a session management function and packet data network gateway-control module (SMF+PGW-C) 104, a user plane function and packet data network gateway-user plane module (UPF+PGW-U) 106, and a policy control function (PCF) 120. The AMF 102 receives all connection and session related information from one or more user equipment (UE) devices 144, and handles connection and mobility management tasks. The AMF 102 forwards all messages related to session management to the SMF+PGW-C module 104. The SMF+PGW-C module 104 and UPF+PGW-U module 106 jointly manage sessions and are configured using Control and User Plane Separation (CUPS). The PCF 120 communicates with the SMF+PGW-C module 104, governing control plane functions via defined policy rules. The UPF+PGW-U module 106 can provide access to the Internet 130 for data applications and the IP Multimedia Subsystem (IMS) core module 118 for voice applications. The IMS core module 118 is a separate application core network from the packet core network and supports voice services, messaging, voice calls, etc.

The environment 100 can further include a charging function (CHF) 122 and a binding support function (BSF) 124. The CHF 122 supports online and offline charging features and completes billing functions. The BSF 124 tracks sessions that are located anywhere in the environment 100, but share common criteria, such as subscriber identifiers. The BSF 124 communicates with the PCF 120 and binds application-function requests to specific PCF instances, enabling policy scaling of the environment 100.

The environment 100 also includes a gNB 108 (i.e., a 5G base station), which handles run-side aspects of the network environment 100 and communicates, either directly or indirectly, with the packet core network elements such as AMF 102, SMF+PGW-C module 104, and UPF+PGW-U module 106.

The environment 100 further includes network elements to manage user or subscriber information. For example, the environment 100 includes an authentication service function (AUSF) 110 for user authentication and a unified data management (UDM) module 112. The user database is stored in a unified data repository (UDR) 114. The UDM 112 communicates with the AMF 102, AUSF 110, and the UDR 114 to provide centralized control of network user data. For interworking with 2G, 3G, and 4G network elements, the environment 100 also includes a Home Subscriber System and Home Location Register (HSS/HLR) module 116, which stores subscriber information, location and SIM details, and authentication keys.

The environment 100 further includes a service communication proxy (SCP) 126 and a network repository function (NRF) 128. In accordance with current 5G standards, network functions are based on HTTP version 2, and use the SCP 126 and NRF 128 to communicate. The NRF 128 is used to discover network functions in the environment 100, and the SCP 126 is used to provide a single point of entry for a cluster of discovered network functions, serving as a central control point in the signaling network core.

The environment 100 further includes a security edge protection proxy (SEPP) 132, a diameter edge agent and diameter routing agent (DEA/DRA) module 134, and a domain name system (DNS) 136. The SEPP 132 is a security proxy through which all signaling traffic across operator networks is expected to transit. The DEA/DRA module 134 manages traffic and congestion of messages routed across the environment 100, routing signaling traffic and performing load balancing, relay, proxy and redirect functions within a carrier or interworking with other carriers. The DNS 136 is a naming database in which internet domain names are located and translated into internet protocol (IP) addresses.

The environment 100 further includes a short message service center (SMSC) 138 and a multimedia message service center (MMSC) 140 configured to receive, store, route, and forward SMS messages and MMS messages, respectively.

The network environment 100 is configured to interact with external systems 142. In some implementations, the external systems 142 can include another network such as a 4G or 5G roaming partner network. For example, the environment 100 can interact with a roaming partner network using an IP Packet eXchange (IPX) telecommunications interconnection model provided between the two network environments. In other examples, the environment 100 can interact directly with the roaming partner network environment without an IPX provider in between the two networks.

In some implementations, the external systems 142 can include a message aggregator configured to aggregate messages and route a portion of the aggregated messages to the environment 100. For example, the aggregated messages can be SMS or MMS messages.

The UE 144 can interact with the network environment 100 indirectly through the external systems 142 or directly with the network environment 100 (e.g., via the gNB 108). In some cases, the UE 144 can be a subscriber to the network environment 100 (e.g., a subscriber to a service provider of the cellular network). In other cases, the UE 144 can be a non-subscriber roaming on the network environment 100.

In some cases, subscribers of the network environment 100 can be of multiple types. For example, subscribers can include high-priority subscribers and non-high-priority subscribers.

High priority subscribers can include, for example, government officials, emergency responders etc., for who the data traffic from corresponding UEs are prioritized over other users. In some implementations, the high-priority subscribers can include subscribers of a paid service to prioritize the data traffic from the corresponding UEs. Subscribers who do not fall into the high-subscriber category can generally be referred to as non-high-priority subscribers. A network may be set up such that data traffic from UEs associated with high priority subscribers is prioritized over data traffic from UEs associated with non-high-priority subscribers. While this document uses only two categories of subscribers to illustrate the inventive concepts, the technology described herein may be extended to higher number of categories. For example, multiple categories of subscribers—with each category having a corresponding priority level—are within the scope of the technology described herein. Further, the categories can be defined in various ways. For example, in the context of a private network associated with an organization, employees above a certain level within the organization's hierarchy can be designated as high-priority users of the corresponding network.

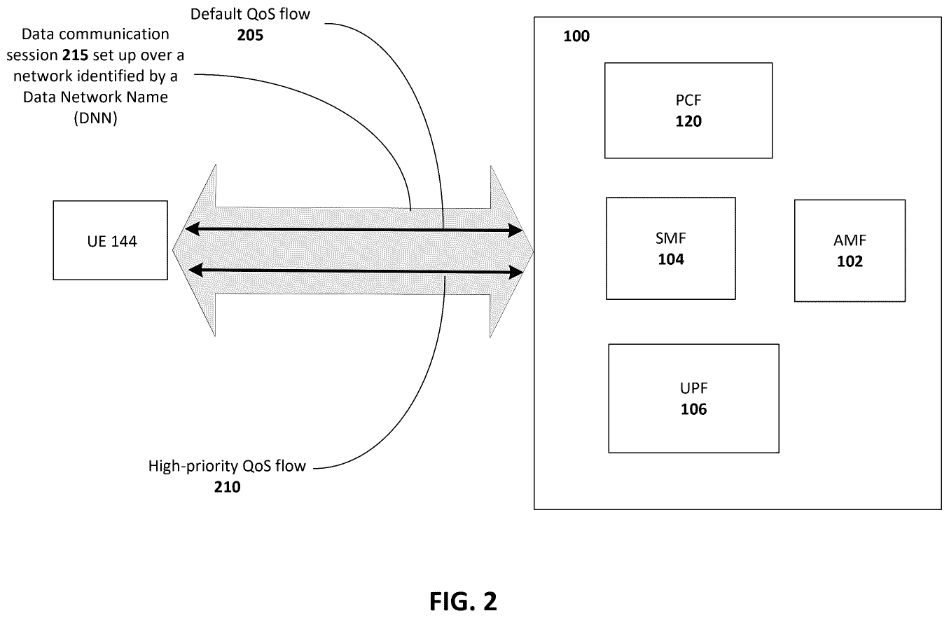

To support high-priority subscribers or users, a network can facilitate establishment of an appropriate data communication session that is provisioned with adequate network resources to maintain a threshold QoS flow for the high-priority data traffic to and from the corresponding UEs. However, in some cases, assigning all data traffic for a high-priority user to a high-QoS data communication session can lead to sub-optimal usage of resources. For example, a high-priority user may use the same UE for both high-priority applications (e.g. a video conference with a government agency) as well as non-high-priority purposes (e.g. ordering pizza)—within a same data communication session. In the absence of differential treatment between high-priority data packets and non-high priority data packets, unnecessary overuse of network resources may occur. For example, routing data packets pertaining to a pizza order over a high QoS data communication session can lead to frivolous use of valuable network resources and power. FIG. 2 is a schematic diagram illustrating routing of data packets over multiple QoS flows—depending on priority level of packets—within a same data communication session for high-priority subscribers. By providing a solution that facilitates differential treatment of high-priority and non-high-priority data packets within a same data communication session, the system illustrated in FIG. 2 may prevent or at least reduce misuse of network resources and/or power consumption.

In some implementations, the solution illustrated in FIG. 2 includes establishment of multiple QoS flows 205 and 210 within a same data communication session 215 between a UE 144 and the network environment 100. For example, in addition to a default QoS flow for non-high-priority traffic, a dedicated QoS flow can be set up for high-priority traffic within the same data communication session 215 established by using a Data Network Name (DNN) over a network slice. If data traffic meets the criteria for being deemed as high-priority, the traffic is mapped to the dedicated QoS flow, otherwise the traffic is routed through the default QoS flow. In some implementations, only UEs associated with high-priority users can establish both the dedicated QoS flow and the default QoS flow by using a dedicated slice and/or DNN for data services, and UEs associated with non-high-priority users can only establish the default QoS flow with a different slice and/or DNN. As such, the technology described herein separates priority and non-priority traffic for high-priority users at QoS flow level such that the traffic is processed/managed and routed differently based on the priority level.

For a 5G-SA, the data communication session 215 can be a protocol data unit (PDU) session established between the UE 144, 5G RAN and core of the network environment 100. In some implementations, a PDU session is a logical connection configured to allow transmission of packet-switched data between the UE (such as a smartphone or IoT device) and a data network via a 5G SA. In some implementations, PDU sessions are established and managed by the AMF 102 and SMF 104. In some implementations, a PDU session can be configured to facilitate efficient and customized handling of packet-switched data traffic between a UE and the 5G SA core to support various use cases with varying performance requirements.

In the example of FIG. 2, a data communication session 215 (e.g. a PDU session) set up between the UE 144 and the network environment 100 can include multiple QoS flow paths each associated with a corresponding set of QoS parameters. Specifically, the data communication session can include a default QoS flow 205 parameterized by a first set of QoS parameters, and a high-priority QoS flow 210 defined by a second, different set of QoS parameters. The flow paths can be implemented using corresponding sets of network resources configured to provide the corresponding QoS. The network resources associated with the high-priority QoS flow 210 are configured to provide a higher QoS as compared to the network resources associated with the default QoS flow 205. Although the example in FIG. 2 illustrates only two QoS flows, higher number of distinct QoS flows—each with its own corresponding QoS parameters and implemented using corresponding set of network resources—is within the scope of the technology described herein. In addition, the QoS flows can be specific to individual subscribers or UEs, and different priority levels of subscribers can have different QoS parameters associated with each QoS flow. For example, priority level 1 subscriber's high priority QoS flow parameters can be different from that of priority level 2 subscriber's high priority QoS flow. The multiple QoS flows can be established during establishment of the data communication session 215. In some implementations, a non-default QoS flow can be set up on an on-demand basis.

Various QoS parameters can be used to define/characterize a QoS flow. Examples of QoS parameters can include Allocation and Retention Priority (ARP) that determines the priority level for allocating and retaining network resources for the particular QoS flow. Specifically, ARP can be configured to influence how the network prioritizes traffic during network congestion or resource scarcity. For example, a QoS flow (or communication session in general) with a relatively higher ARP value may be prioritized for requisite resources to maintain its QoS (as parameterized, for example, latency, throughput, and reliability) as compared to another QoS flow with a relatively lower ARP value.

The QoS parameters can also include, for example, priority, packet delay budget (PDB), packet error rate (PER), bandwidth, and traffic handling priority (THP). In some implementations, the QoS parameters can include 5G QoS Indicator (5QI), which can be a numerical value (e.g., ranging from 1 to 127 for standardized and 128 to 254 for non-standardized) representing a specific set of QoS characteristics/parameters defined for the QoS flow. Examples of typical 5QI values include 5QI=1—suitable for conversational voice applications with high priority, 5QI=9—used for standard internet browsing and file downloads with low priority, and 5QI=65—reserved for mission critical user plane Push to Talk voice applications. In some implementations, the default QoS flow can have a 5QI value of 9 while the high-priority QoS flow has a value of 6 or higher.

In some implementations, a QoS flow can be represented using a QoS flow identifier (QFI). 5G data packets can include—in the packet header, for example—a QFI field that identifies an appropriate QoS flow for the packet. High-priority and non-high-priority traffic can be distinguished based on the QFI parameter/field of a data packet and/or one or more other parameters associated with the data packet. In some implementations, the one or more other parameters can include IP address/port number and/or identification of protocol included in the data packet. For example, packets destined to a particular IP address and/or originating from a particular IP address can be designated as a high-priority data packet. Similarly, a data packet that conforms to a particular communication protocol, or is associated with a particular application (e.g., a secure video calling application used between governmental agencies) can be designated as a high-priority data packet. In some implementations, the filtering criteria to distinguish between high-priority and non-high-priority data packets (or among multiple categories of priority) can be configured by the PCF 120 during establishment of a PDU session, and potentially sent to the SMF 104 for forwarding to the UE 144 and UPF 106.

The filtering criteria can be utilized to determine a level of priority of a data packet to route the packet accordingly in a corresponding QoS flow. For example, the UE 144 can be configured to execute the filtering criteria on the uplink traffic and a module of the 5G core (e.g., the UPF 106) can be configured to execute the filtering criteria on the downlink traffic. Responsive to determining—upon executing the filtering criteria—whether a data packet is a high-priority packet or non-high-priority packet, the packet is routed accordingly to a corresponding QoS flow.

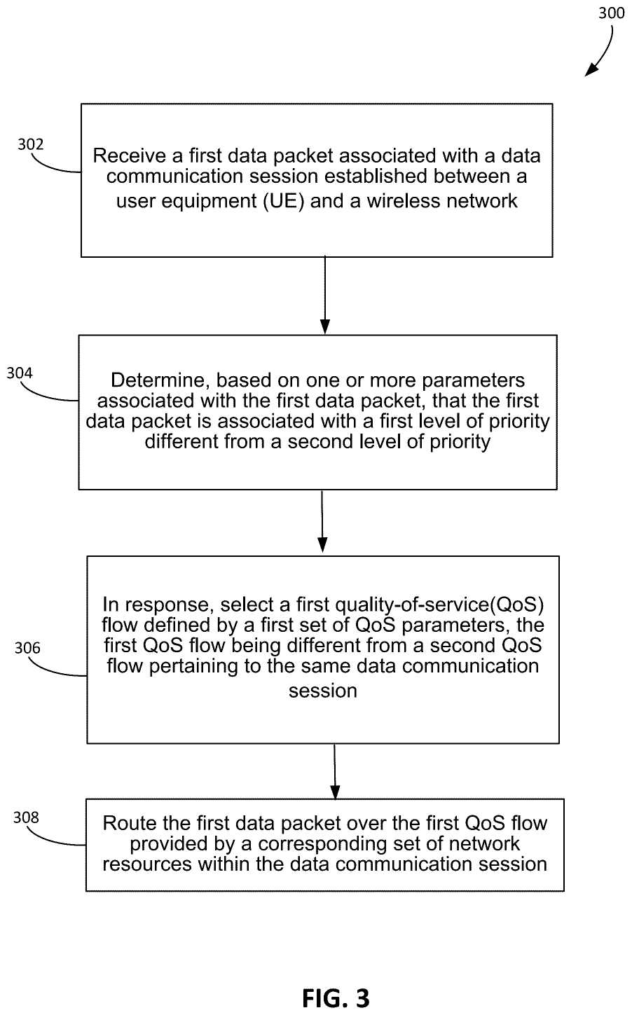

FIG. 3 illustrates a flowchart of an example process 300 for routing of data packets over multiple QoS flows within a same data communication session. The operations of the process 300 can be carried out, for example, at one or more functional modules described above with reference to FIG. 1. For example, for data packets in uplink traffic, the operations of the process 300 can be executed by one or more processors of the UE 144. For data packets in downlink traffic, the operations of the process 300 can be executed by one or more processors of UPF 106 associated with the network environment 100.

Operations of the process 300 include receiving a first data packet associated with a data communication session established between a user equipment (UE) and a wireless network such as a 5G SA network (302). The UE can be substantially similar to the UE 144 and the wireless network can be substantially similar to a 5G SA network described above with reference to FIG. 1. In some implementations, the data communication session can be a protocol data unit (PDU) session established between the UE and a 5G SA network. Operations of the process 300 also include determining, based on one or more parameters associated with the first data packet (and one or more configured rules such as QoS rules or Packet Detection Rules (PDR)), that the first data packet is associated with a first level of priority different from a second level of priority. For example, the first level of priority can pertain to prioritized traffic or a prioritized application (304). The levels of priority and non-priority QoS parameters can be configured to define a relative prioritization of data packets within the 5G SA network, as described above with reference to FIG. 1.

The process also includes selecting, responsive to determining that the first data packet is associated with a first level of priority (e.g., the first data packet pertains to prioritized traffic or a prioritized application), a first QoS flow (e.g., a priority QoS flow) defined by a set of QoS parameters (306). A set of network resources is allocated by the 5G network accordingly based on the set of QoS parameters to support the associated QoS flow. Network resources may vary based on the sets of QoS parameters configured for each corresponding QoS flow (including at least the default QoS flow). Each of the priority QoS flow and the default QoS flow pertain to the same data communication session. In some implementations, both the priority QoS flow and the default QoS flow are set up during establishment of the PDU session. In some implementations, only the default QoS flow is set up during the establishment of the PDU session, and other non-default, i.e. dedicated, priority QoS flow(s) are set up on demand, i.e. triggered by an application or a certain type of traffic. In some implementations, the one or more parameters associated with each QoS rule or Packet Detection Rule (PDR) includes one or more of: an IP address associated with the applications or certain types of traffic, a port number associated with an origin or destination of the application or platform, an application associated with the traffic, or a communication protocol associated with the application or traffic types. In some implementations, determining that the first data packet is associated with priority traffic comprises accessing one or more filtering criteria in the QoS rule or PDR (packet detection rule) configured by a policy control function (PCF) module of the 5G-SA network.

In some implementations, operations of the process 300 can also include receiving a second data packet associated with the data communication session, and determining, based on one or more parameters associated with the second data packet and the one or more configured rules (e.g., the QoS rule or Packet Detection Rule (PDR)), that the second data packet is associated with the second level of priority (e.g., the second data packet does not correspond to prioritized traffic or a prioritized application). In response to determining that the second data packet is associated with a second level of priority (e.g., the second data packet is not associated with the prioritized traffic or a prioritized application), the default QoS flow can be selected to transfer/route the second data packet. The default QoS flow is associated with a set of network resources defined by the default QoS flow parameters.

Operations of the process 300 also includes routing the first data packet over the priority QoS flow supported by a set of network resources (308). Operations of the process 300 can also include routing the second data packet over the default QoS flow processed by another set of network resources within the same data communication session.

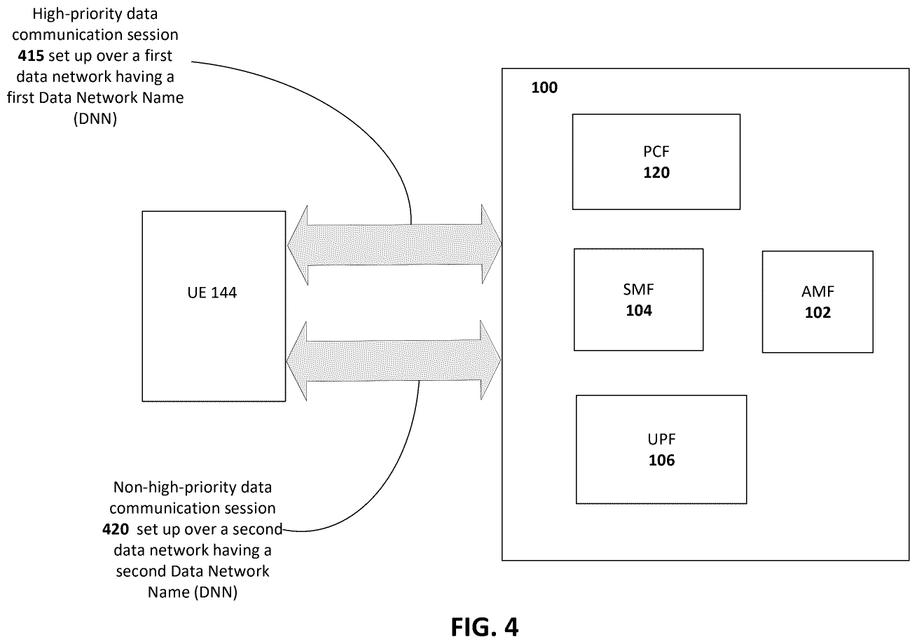

In another aspect, to separate high-priority and non-high-priority traffic, the two types of traffic may be routed through separate DNNs altogether. FIG. 4 is a schematic diagram illustrating such a scheme of routing of data packets over multiple data communication sessions with respective QoS parameters. In some implementations, a high-priority data communication session 415 can be set up with a first DNN, and a non-high-priority data communication session 420 can be set up with a second DNN. While only two data communication sessions corresponding to two DNNs are illustrated in FIG. 4, additional number of data communication sessions can be set up in some implementations, with each session being associated with a corresponding priority level of data packets.

In some implementations, the high-priority data communication session 415 identified by the first DNN can be associated with specified applications and/or access to certain networks (e.g., high security government networks) defined, for example, in a set of rules. List of rules associated with the relevant applications and networks can be configured and stored in the UE or a SIM associated with the UE. In some implementations, if a URL requested from the UE, or an application used on the UE, is determined—based on the pre-configured list of rules—as high-priority, the high priority session can be established by using the priority DNN, and the corresponding data traffic can be routed through the high-priority data communication session. On the other hand, if the URL or application is not determined to be high-priority, the non-priority session can be established using the non-priority DNN, and the corresponding data traffic is routed through the non-high-priority communication session 420.

In some implementations, the high-priority data communication session 415 associated with the first DNN can be provisioned only for high-priority users, while non-high-priority users do not have access to the high-priority data communication session 415. In addition, the first DNN can be configured to allow traffic to certain sites/applications only to add another layer of security. The sites themselves can also have their own security (e.g., login credentials to a governmental agency) thereby allowing the system described herein to implement multi-layer high-security applications.

In some implementations, each of the data communication sessions 415 and 420 can be substantially similar to the data communication session 215 described with reference to FIG. 2. For example, one or more of the data communication sessions 415 and 420 may be associated with multiple QoS flows within each session. In such cases, routing of data packets can be done at a finer granularity. For example, relative priorities may be determined for data packets being routed through the high-priority communication session 415 and routed through corresponding QoS flows accordingly. Similarly, in some implementations, multiple QoS flows can be defined within the non-high-priority communication session 420.

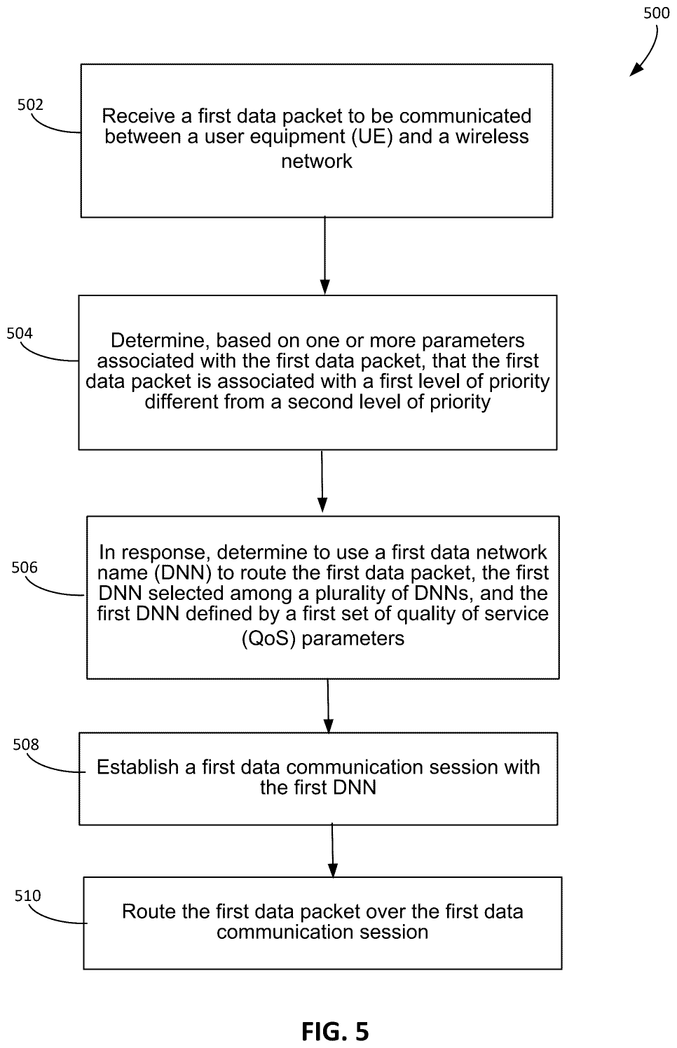

FIG. 5 illustrates a flow chart of an example process 500 for routing of data packets over multiple data communication sessions with respective QoS parameters. Operations of the process 500 can be executed, at least in part, at a UE, such as the UE 144 described above with reference to FIG. 1. Operations of the process 500 include receiving a first data packet to be communicated between a user equipment (UE) and a wireless network (502). In some implementations, the wireless network can be a 5G SA network, and the first data packet may be communicated between the UE and a website or an application server via the 5G SA network. In some implementations, the wireless network can be substantially similar to a 5G SA network described above with reference to FIG. 1. In some implementations, the data communication session can be a protocol data unit (PDU) session established between the UE and a 5G SA network.

Operations of the process 500 also include determining, based on one or more parameters associated with the first data packet and one or more configured rules, that the first data packet is associated with a first level of priority different from a second level of priority (504). The first and second levels of priority can represent various levels of prioritized traffic defined by corresponding sets of QoS parameters, which are configured within the 5G SA network, as described above with reference to FIG. 1. The one or more parameters associated with the first data packet can be accounted for in the one or more configured rules, and can include one or more of: an IP address and/or a port number of the source and/or destination associated with the first data packet, a network or application associated with a source or destination of the first data packet, or a communication protocol associated with the first data packet. In some implementations, determining that the first data packet is associated with priority traffic can include accessing one or more rules stored at the UE or a subscriber identification module (SIM) associated with the UE.

Operations of the process 500 also includes determining, in response, a first, priority DNN over a network slice to route the first data packet, the QoS flow associated with the priority DNN over the network slice defined by a first set of QoS parameters is different from a second QoS flow defined by a second set of QoS parameters associated with a second, non-priority DNN over the same or a different network slice (506). The first, priority DNN and the associated network slice is selected from among multiple available DNNs and network slices including the second, non-priority DNN and the associated network slice. In some implementations, different DNNs for different traffic types can be on the same network slice, and in some implementations, the same DNN for different traffic types can be differentiated by using different network slices.

In some implementations, operations of the process 500 also includes receiving a second data packet, and determining, based on the configured selection rules and one or more parameters associated with the second data packet, that the second data packet is associated with the second level of priority (e.g., a level of priority associated with non-priority traffic). The operations of the process can further include determining to use, in response, the second DNN and associated network slice to route the second data packet. Accordingly, a second data communication session is established with the second DNN over the corresponding network slice, and the second data packet is routed over the second data communication session established with the second DNN. In some implementations, the first data communication session and the second data communication session can be established at the same time, and served by the same or different SMF and/or UPF, such that the priority and non-priority traffic can be transferred simultaneously between the UE and the 5G core.

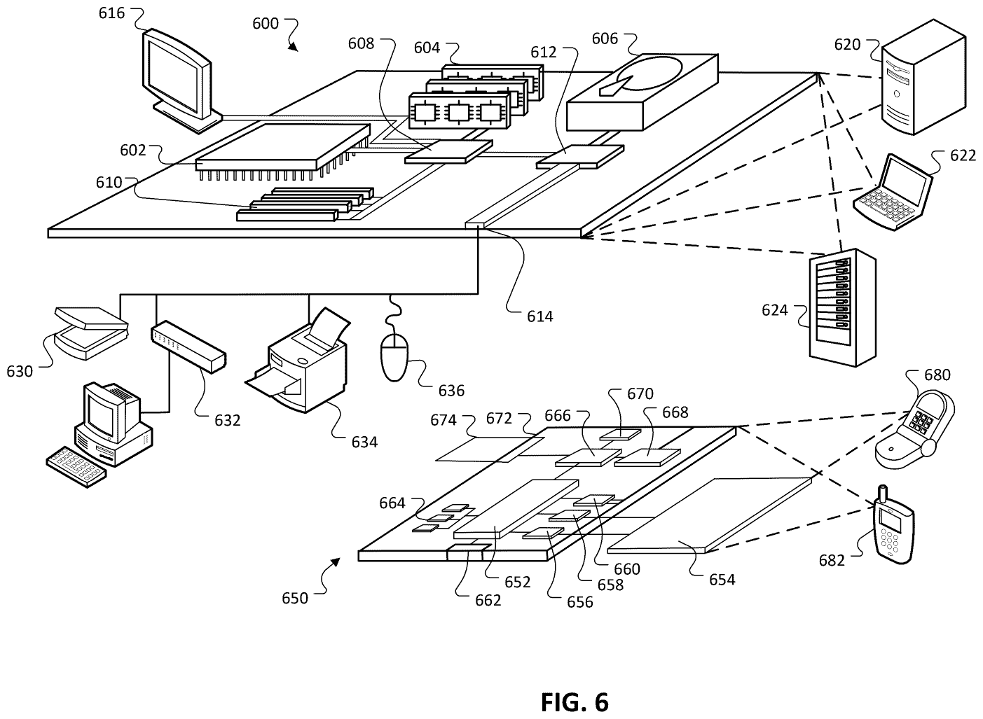

FIG. 6 shows an example of a computing device 600 and a mobile computing device 650 that are employed to execute implementations of the present disclosure. The computing device 600 is intended to represent various forms of digital computers, such as laptops, desktops, workstations, personal digital assistants, servers, blade servers, mainframes, and other appropriate computers. The mobile computing device 650 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting. The computing device 600 and/or the mobile computing device 650 can form at least a portion of the network environments (e.g., environment 100) described above. The computing device 600 and/or the mobile computing device 650 can also form at least a portion of the UE 144 described above. In some implementations, the network functions and/or network entities described above can be implemented using a cloud infrastructure including multiple computing devices 600 and/or mobile computing devices 650.

The computing device 600 includes a processor 602, a memory 604, a storage device 606, a high-speed interface 608, and a low-speed interface 612. In some implementations, the high-speed interface 608 connects to the memory 604 and multiple high-speed expansion ports 610. In some implementations, the low-speed interface 612 connects to a low-speed expansion port 614 and the storage device 604. Each of the processor 602, the memory 604, the storage device 606, the high-speed interface 608, the high-speed expansion ports 610, and the low-speed interface 612, are interconnected using various buses, and may be mounted on a common motherboard or in other manners as appropriate. The processor 602 can process instructions for execution within the computing device 600, including instructions stored in the memory 604 and/or on the storage device 606 to display graphical information for a graphical user interface (GUI) on an external input/output device, such as a display 616 coupled to the high-speed interface 608. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 604 stores information within the computing device 600. In some implementations, the memory 604 is a volatile memory unit or units. In some implementations, the memory 604 is a non-volatile memory unit or units. The memory 604 may also be another form of a computer-readable medium, such as a magnetic or optical disk.

The storage device 606 is capable of providing mass storage for the computing device 600. In some implementations, the storage device 606 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 602, perform one or more methods, such as those described above. The instructions can also be stored by one or more storage devices, such as computer-readable or machine-readable mediums, such as the memory 604, the storage device 606, or memory on the processor 602.

The high-speed interface 608 manages bandwidth-intensive operations for the computing device 600, while the low-speed interface 612 manages lower bandwidth-intensive operations. Such allocation of functions is an example only. In some implementations, the high-speed interface 608 is coupled to the memory 604, the display 616 (e.g., through a graphics processor or accelerator), and to the high-speed expansion ports 610, which may accept various expansion cards. In the implementation, the low-speed interface 612 is coupled to the storage device 606 and the low-speed expansion port 614. The low-speed expansion port 614, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 614 through a network adapter. Such network input/output devices may include, for example, a switch or router.

The computing device 600 may be implemented in a number of different forms, as shown in the FIG. 6. For example, it may be implemented as a standard server 620, or multiple times in a group of such servers. In addition, it may be implemented in a personal computer such as a laptop computer 622. It may also be implemented as part of a rack server system 624. Alternatively, components from the computing device 600 may be combined with other components in a mobile device, such as a mobile computing device 650. Each of such devices may contain one or more of the computing device 600 and the mobile computing device 650, and an entire system may be made up of multiple computing devices communicating with each other.

The mobile computing device 650 includes a processor 652; a memory 664; an input/output device, such as a display 654; a communication interface 666; and a transceiver 668; among other components. The mobile computing device 650 may also be provided with a storage device, such as a micro-drive or other device, to provide additional storage. Each of the processor 652, the memory 664, the display 654, the communication interface 666, and the transceiver 668, are interconnected using various buses, and several of the components may be mounted on a common motherboard or in other manners as appropriate. In some implementations, the mobile computing device 650 may include a camera device(s).

The processor 652 can execute instructions within the mobile computing device 650, including instructions stored in the memory 664. The processor 652 may be implemented as a chipset of chips that include separate and multiple analog and digital processors. For example, the processor 652 may be a Complex Instruction Set Computers (CISC) processor, a Reduced Instruction Set Computer (RISC) processor, or a Minimal Instruction Set Computer (MISC) processor. The processor 652 may provide, for example, for coordination of the other components of the mobile computing device 650, such as control of user interfaces (UIs), applications run by the mobile computing device 650, and/or wireless communication by the mobile computing device 650.

The processor 652 may communicate with a user through a control interface 658 and a display interface 656 coupled to the display 654. The display 654 may be, for example, a Thin-Film-Transistor Liquid Crystal Display (TFT) display, an Organic Light Emitting Diode (OLED) display, or other appropriate display technology. The display interface 656 may include appropriate circuitry for driving the display 654 to present graphical and other information to a user. The control interface 658 may receive commands from a user and convert them for submission to the processor 652. In addition, an external interface 662 may provide communication with the processor 652, so as to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory 674 may also be provided and connected to the mobile computing device 650 through an expansion interface 672, which may include, for example, a Single in Line Memory Module (SIMM) card interface. The expansion memory 674 may provide extra storage space for the mobile computing device 650, or may also store applications or other information for the mobile computing device 650. Specifically, the expansion memory 674 may include instructions to carry out or supplement the processes described above, and may include secure information also. Thus, for example, the expansion memory 674 may be provided as a security module for the mobile computing device 650, and may be programmed with instructions that permit secure use of the mobile computing device 650. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 652, perform one or more methods, such as those described above. The instructions can also be stored by one or more storage devices, such as one or more computer-readable or machine-readable mediums, such as the memory 664, the expansion memory 674, or memory on the processor 652. In some implementations, the instructions can be received in a propagated signal, such as, over the transceiver 668 or the external interface 662.

The mobile computing device 650 may communicate wirelessly through the communication interface 666, which may include digital signal processing circuitry where necessary. The communication interface 666 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS), IP Multimedia Subsystem (IMS) technologies, and 5G technologies. Such communication may occur, for example, through the transceiver 668 using a radio frequency. In addition, short-range communication, such as using a Bluetooth or Wi-Fi, may occur. In addition, a Global Positioning System (GPS) receiver module 670 may provide additional navigation-and location-related wireless data to the mobile computing device 650, which may be used as appropriate by applications running on the mobile computing device 650.

The mobile computing device 650 may also communicate audibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound (e.g., voice messages, music files, etc.) and may also include sound generated by applications operating on the mobile computing device 650.

The mobile computing device 650 may be implemented in a number of different forms, as shown in FIG. 6. For example, it may be implemented in the UE described with respect to FIG. 1. Other implementations may include a phone device 680, a personal digital assistant 682, and a tablet device (not shown). The mobile computing device 650 may also be implemented as a component of a smart-phone, AR device, or other similar mobile device.

The computing device 600 may be implemented in the network environment 100 described above with respect to FIGS. 1-5.

Computing device 600 and/or 650 can also include USB flash drives. The USB flash drives may store operating systems and other applications. The USB flash drives can include input/output components, such as a wireless transmitter or USB connector that may be inserted into a USB port of another computing device.

Other embodiments and applications not specifically described herein are also within the scope of the following claims. Elements of different implementations described herein may be combined to form other embodiments.

What is claimed is:

1. A method comprising:
receiving, at one or more computing devices, a first data packet associated with a data communication session established between a user equipment (UE) and a wireless network ;
determining, based on one or more parameters associated with the first data packet and one or more configured rules, that the first data packet is associated with a first level of priority different from a second level of priority, the first and second levels of priority defining a relative prioritization of data packets within the wireless network;
responsive to determining that the first data packet is associated with the first level of priority, selecting—from (i) a first quality-of service (QoS) flow associated with a set of filter criteria and (ii) a second QoS flow associated with different set of filter criteria—the first QoS flow, wherein the first QoS flow is defined by a first set of QoS parameters associated with a first set of network resources, the first QoS flow being different from a second QoS flow defined by a second set of QoS parameters associated with a second set of network resources, wherein each of the first QoS flow and the second QoS flow pertain to the same data communication session; and
routing the first data packet over the first QoS flow supported by the first set of network resources within the data communication session.

2. The method of claim 1, further comprising:
receiving, at the one or more computing devices, a second data packet associated with the data communication session;
determining, based on one or more parameters associated with the second data packet and the one or more configured rules, that the second data packet is associated with the second level of priority;
responsive to determining that the second data packet is associated with the second level of priority, selecting the second QoS flow defined by the second set of QoS parameters associated with the second set of network resources; and
routing the second data packet over the second QoS flow provided by the second set of network resources within the data communication session.

3. The method of claim 1, wherein both the first QoS flow and the second QoS flow are set up during establishment of a protocol data unit (PDU) session between the UE and the wireless network.

4. The method of claim 1, wherein the one or more parameters associated with the first data packet comprise at least one of: (i) an IP address associated with a source and/or destination of the first data packet, (ii) a port number associated with an origin or destination of the first data packet, (iii) an application associated with the first data packet, or (iv) a communication protocol associated with the first data packet.

5. The method of claim 1, wherein the wireless network comprises a radio access network (RAN) and a core network associated with a 5G standalone (SA) network, and determining that the first data packet is associated with the first level of priority comprises accessing one or more filtering criteria configured by a policy control function (PCF) module of the core network of the 5G SA network.

6. The method of claim 1, wherein the one or more computing devices are associated with the user equipment (UE), and the first data packet is a portion of uplink data traffic originating at the UE.

7. The method of claim 1, wherein the wireless network comprises a radio access network (RAN) and a core network associated with a 5G standalone (SA) network, and the one or more computing devices are associated with a network module of the core network of the 5G SA network, and the first data packet is a portion of downlink data traffic being transmitted to the UE.

8. The method of claim 1, wherein the wireless network comprises a radio access network (RAN) and a core network associated with a 5G standalone (SA) network, and the data communication session is a protocol data unit (PDU) session established between the UE and the 5G SA network.

9. A system comprising:
memory configured to store computer-readable instructions; and
one or more computing devices operatively coupled to the memory, configured to execute the computer-readable instructions to perform operations comprising:
receiving a first data packet associated with a data communication session established between a user equipment (UE) and a wireless network,
determining, based on one or more parameters associated with the first data packet and one or more configured rules, that the first data packet is associated with a first level of priority different from a second level of priority, the first and second levels of priority defining a relative prioritization of data packets within the wireless network,
responsive to determining that the first data packet is associated with the first level of priority, selecting—from (i) a first quality-of service (QoS) flow associated with a set of filter criteria and (ii) a second QoS flow, associated with different set of filter criteria—the first QoS flow defined by a first set of QoS parameters associated with a first set of network resources, the first QoS flow being different from a second QoS flow defined by a second set of QoS parameters associated with the second set of network resources, wherein each of the first QoS flow and the second QoS flow pertains to the same data communication session, and
routing the first data packet over the first QoS flow supported by the first set of network resources within the data communication session.

10. The system of claim 9, wherein the operations further comprise:
receiving a second data packet associated with the data communication session;
determining, based on one or more parameters associated with the second data packet and the one or more configured rules, that the second data packet is associated with the second level of priority;
responsive to determining that the second data packet is associated with the second level of priority, selecting the second QoS flow defined by the second set of QoS parameters associated with the second set of network resources; and
routing the second data packet over the second QoS flow provided by the second set of network resources within the data communication session.

11. The system of claim 9, wherein both the first QoS flow and the second QoS flow are set up during establishment of a protocol data unit (PDU) session between the UE and the wireless network.

12. The system of claim 9, wherein the one or more parameters associated with the first data packet comprise at least one of: (i) an IP address associated with a source and/or destination of the first data packet, (ii) a port number associated with an origin or destination of the first data packet, (iii) an application associated with the first data packet, or (iv) a communication protocol associated with the first data packet.

13. The system of claim 9, wherein the wireless network comprises a radio access network (RAN) and a core network associated with a 5G standalone (SA) network, and determining that the first data packet is associated with the first level of priority comprises accessing one or more filtering criteria configured by a policy control function (PCF) module of the core network of the 5G SA network.

14. The system of claim 9, wherein the one or more computing devices are associated with the user equipment (UE), and the first data packet is a portion of uplink data traffic originating at the UE.

15. The system of claim 9, wherein the wireless network comprises a radio access network (RAN) and a core network associated with a 5G standalone (SA) network, the one or more computing devices are associated with a network module of the core network of the 5G SA network, and the first data packet is a portion of downlink data traffic being transmitted to the UE.

16. The system of claim 9, wherein the wireless network comprises a radio access network (RAN) and a core network associated with a 5G standalone (SA) network, and the data communication session is a protocol data unit (PDU) session established between the UE and the 5G SA network.

17. One or more on-transitory computer-readable storage devices configured to store computer-readable instructions, which, upon execution by one or more computing devices cause the one or more computing devices to perform operations comprising:
receiving a first data packet associated with a data communication session established between a user equipment (UE) and a wireless network;
determining, based on one or more parameters associated with the first data packet and one or more configured rules, that the first data packet is associated with a first level of priority different from a second level of priority, the first and second levels of priority defining a relative prioritization of data packets within the wireless network;
responsive to determining that the first data packet is associated with the first level of priority, selecting—from (i) a first quality-of service (QoS) flow associated with a set of filter criteria and (ii) a second QoS flow, associated with different set of filter criteria—the first QoS flow defined by a first set of QoS parameters associated with a first set of network resources, the first QoS flow being different from a second QoS flow defined by a second set of QoS parameters associated with the second set of network resources, wherein each of the first QoS flow and the second QoS flow pertains to the same data communication session; and
routing the first data packet over the first QoS flow supported by the first set of network resources within the data communication session.

18. The one or more non-transitory computer-readable storage devices of claim 17, wherein the operations further comprise:
receiving a second data packet associated with the data communication session;
determining, based on one or more parameters associated with the second data packet and the one or more configured rules, that the second data packet is associated with the second level of priority;
responsive to determining that the second data packet is associated with the second level of priority, selecting the second QoS flow defined by the second set of QoS parameters associated with the second set of network resources; and
routing the second data packet over the second QoS flow provided by the second set of network resources within the data communication session.

19. The one or more non-transitory computer-readable storage devices of claim 17, wherein the one or more parameters associated with the first data packet comprise at least one of:
(i) an IP address associated with a source and/or destination of the first data packet, (ii) a port number associated with an origin or destination of the first data packet, (iii) an application associated with the first data packet, or (iv) a communication protocol associated with the first data packet.

20. The one or more non-transitory computer-readable storage devices of claim 17, wherein the wireless network comprises a radio access network (RAN) and a core network associated with a 5G standalone (SA) network, and determining that the first data packet is associated with the first level of priority comprises accessing one or more filtering criteria configured by a policy control function (PCF) module of the core network of the 5G SA network.
